(19) United States
(12) Patent Application Publication
(10) Pub. No.: US 2007/0055881 A1
(43) Pub. Date: Mar. 8, 2007

(54) Method for securely exchanging public key certificates in an electronic device

(76) Inventors: Kenneth C. Fuchs, Winfield, IL (US); Timothy M. Langham, Streamwood, IL (US); Brian W. Pruss, Streamwood, IL (US)

Correspondence Address: MOTOROLA, INC., 1303 EAST ALGONQUIN ROAD, IL01/3RD, SCHAUMBURG, IL, 60196, US

(21) Appl. No.: 11/218,370

(22) Filed: Sep. 2, 2005

(51) Int. Cl. H04L 9/00

(52) U.S. Cl. 713/175

(57) ABSTRACT

A method for securely exchanging public key certificates in an electronic device (400) using a single or dual level of public key includes obtaining a replacement public key certificate (401) to replace an original public key certificate. The replacement public key certificate is signed (403) using the private key of the original public key certificate. The signature of the original public key certificate is validated (407) and the replacement public key certificate is written to memory where the original public key certificate cannot again be used as a default. Thus, the method of the invention uses either a single signature or combination of double signatures to permit transfer of signing authority to an independent third party. Once the original secondary public key is overwritten, the manufacturer's original secondary public key may no longer be used and the process is irreversible.

### TECHNICAL FIELD

This invention relates in general to the verification and exchange of data and more particularly to the exchange of public key certificates used for authenticating identity before exchange.

### BACKGROUND

In the field of information security, digital signatures are commonly used for validating the authenticity or the source of information. The digital signatures typically operate using public key cryptography. In public key cryptography, there exists a pair of keys to perform the tasks of encryption and decryption. The key that is used for encryption is typically called the “private key” and is generally kept secret. The other key is used for decryption, is called the “public key,” is typically open to the public and is not kept secret. The terms “public key,” “public key certificate,” and “certificate” are often used interchangeably. It is important to note that each public key has a corresponding private key and only these two “matched keys” can be used together for encryption and subsequent decryption. The public/private key pair can be generated by a tool suited for this purpose or may be issued by an entity who wishes to utilize some form of public key cryptography.

The process of authenticating information often requires the use of a digital signature. This process involves signing a document using a “private key” from a private/public key pair. The signature process is carried out by first taking a “hash” of the document data. As is well known in the art, a hash is defined as a one-way mathematical function for which the document was the input. The output of the function is a smaller piece of data that is distinct to the original document. The hash output value is encrypted using the private key. The encrypted hash value is considered to be the “signature” and is typically appended to the original document.

Further to this process, a receiving party is then sent the document or code with the signature. The receiving party may attempt to validate the signature by decrypting the encrypted hash value using a public key certificate. Typically, the receiving party will already be in possession of the “public key” corresponding to the private key used to generate the signature. It can compute its own hash value of the document and compare this value to the hash value sent along with the signature. If these hash values match, then the signature is valid and the document is considered authentic since it must have been signed by the party who issued the original public key certificate.

Thus, a public key certificate operates as an identity certificate which uses a digital signature to bind together a public key with an identity or private key. This identity may include such information as personal and/or organizational names, addresses or other authentication data. The public key certificate can be used to verify the key associated with an individual or device. In many applications, public key cryptography systems use public key certificates to both authenticate data and to control access to computer microprocessors and/or other electronic devices. Since securely exchanging secret keys amongst devices becomes impractical except for substantially small networked environments, public key cryptography provides a way to alleviate this problem.

Since electronic devices use public cryptography to control access to the device, if the device desires other users the ability to send encrypted data, then it need only publish its public key. Any other device possessing that public key can then send the device secure information. The primary reason for receiving secure information is so that a computer virus, “Trojan horse” or other unauthorized data cannot be input to the device. Thus, in order to prevent unauthorized data from entering the device, further methods using public key cryptography have been devised rather than using a single public key. These additional methods often utilize a second public key that must also be verified before authentication can take place. FIG. 1 is a prior art diagram showing an electronic device 50 that utilizes a primary memory 51, secondary memory 52 whose access is controlled by a microprocessor 55 through a communications port 57.

One problem that can occur in devices that use public key certificates to authenticate data occurs when an entity using a device whose access is controlled through public key encryption desires the ability to replace a certificate. The certificate is replaced with that of an independent third party offering signature and/or certificate authority. This is a concern since a manufacturer's key is typically used to maintain complete control of the device and most encryption systems include an ability to revert back to a manufacturer's original key. Moreover, if the user utilizes a third-party public key certificate, some system must be devised to allow such a substitution. If a continuously rewriteable memory is used to store the public key, some method must be created to prevent unauthorized users, who may have access to the original private key, to rewrite the public key certificate using their own key. This process would allow the unauthorized user unfettered access to the data and/or software stored in any rewriteable memory located in the device.

Accordingly, the need exists to provide a secure method for creating a new public key certificate owner who can assume complete control over the device. The new owner should have no means to replace, revoke and/or revert back to the manufacturer's original public key certificate. Additionally, the method should enable the user to delay the issuance of an independent certificate until some later time, enabling the manufacturer to produce one key set without having to provide personalized public keys for each device.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a prior art block diagram illustrating an electronic device whose memories are accessed through a microprocessor.

FIG. 2 is a block diagram illustrating use of the primary or root public key certificate.

FIG. 3 is a block diagram illustrating use of the secondary or replacement public key certificate.

FIG. 3 is a flow chart diagram illustrating operation of an electronic device using public key encryption in a device reset mode.

FIG. 5 is a flow chart diagram illustrating the method for securely exchanging public key certificates.

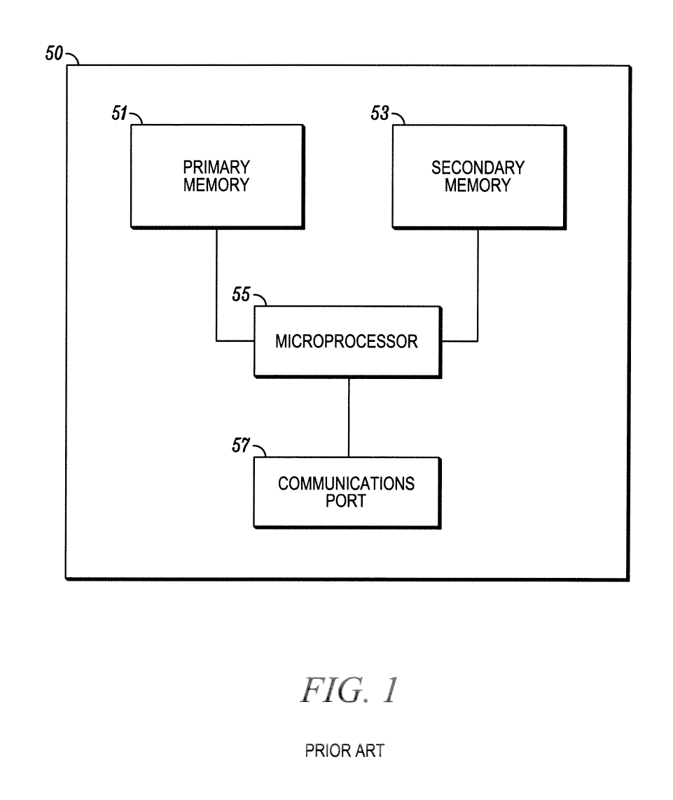

### DETAILED DESCRIPTION

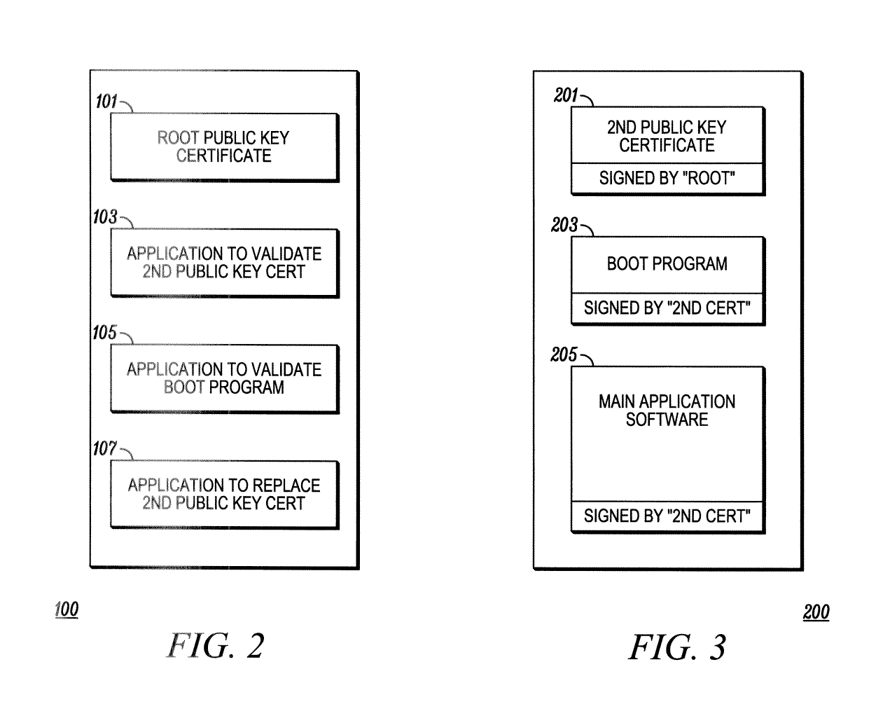

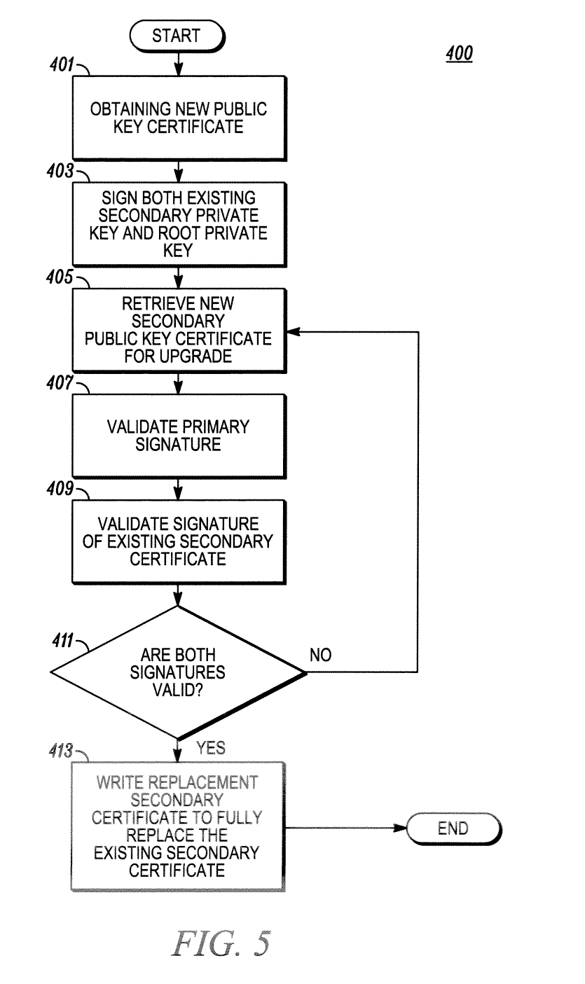

FIG. 2 is a block diagram graphically illustrating the contents of the non-writeable memory 100 as used in an electronic device utilizing public key cryptography. An electronic device may include, but is not limited to, such devices as a personal computer, mobile telephone, pager, or two-way radio transceiver. This memory typically is a read-only memory or the like and includes the primary or “root” public key certificate 101 as well as several software applications are used to perform various functions in an associated electronic device. These software applications include application software used for authenticating the second public key certificate by validating its digital signature 103, an application that will validate the authenticity of the boot program by validating its digital signature 105, and an application that will replace the existing second certificate 107 in accordance with the present invention. As known in the art, the boot program is an operating system or other software used to load application software on the device. Those skilled in the art will recognize that the application to replace the second public key certificate will first validate two signatures before replacing the second certificate. This process is described in better detail in FIG. 5 herein.

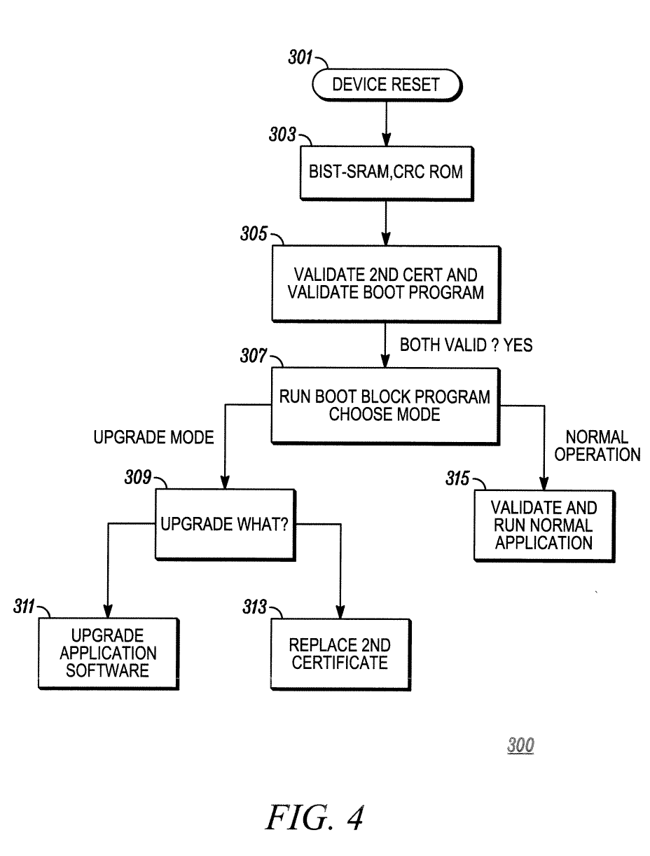

FIG. 3 is block diagram graphically illustrating the contents of the rewriteable memory used in connection with the electronic device. The rewriteable memory is typically flash memory or a hard disk and includes a secondary public key certification 201 that is used to carry out validations on the device's application software. As known in the art, the secondary public key certificate has been previously “signed” by the root private key and that signature information is appended to the certificate 201. The rewritable memory 200 further includes a boot program 203 that operates on a user indication to operate in one of three modes. The boot program may operate in the:
1) Normal mode, where the boot program will perform a digital signature validation over main application software used to operate the electronic device. If valid, the main application software will run on the device;
2) Upgrade Main Software, mode where the boot program 203 retrieves a software upgrade, verifies its validity, and writes the upgrade to memory; or
3) Replace second public key certificate mode, where the boot program will utilize applications 107 that replace the second public key certificate 201. It will be recognized by those skilled in the art that the boot program application software 203 and the main application software 205 will have been previously “signed” by the second private key. This signature information is appended to the boot program. Finally, the main application software 205 is used to operate the principal functions of the electronic device. This software has been previously “signed” by the second private key and that signature information is appended to the software.

FIG. 4 is a flow chart diagram illustrating a device reset 301 function as used in an electronic device using public key encryption. As known in the art, before running application software on the electronic device, the device will typically run built-in self-tests (BIST) 303 in the static random access memory (SRAM) and a cyclic redundancy check (CRC) on the read-only memory (ROM) and then operate to run a validate second certificate application program 305 and validate boot program application by running these application programs 103, 105. These applications will validate signatures over the second certificate and over the boot program as described in FIG. 3. If both signatures are valid, this will run the boot program 307.

With the boot program running 307, and based on a user indication, the boot program will either choose to perform an upgrade procedure or it will proceed to a normal application. If an upgrade procedure is selected, the boot application software will determine what is needed to be upgraded. As noted in FIG. 3, if normal operation is chosen, the boot program will perform signature validation over the main application software 315 and run that application software if valid. If upgrade main software mode is selected 309, the boot program will perform a signature validation over the new application software and, if valid, will write the new application software to replace the existing main application software 205. If the replace second public key certificate mode 309 is chosen, the software application 107 will then be used to replace the second certificate 313. An upgrade to any boot program may also be performed at this time.

Referring now to FIG. 5, the method for securely exchanging public key certificates in an electronic device 400 as noted by the application to replace the second public key certificate 107 in FIG. 2 includes the steps of first preparing or obtaining 401 a new or replacement public key certificate where it is signed 403 by both the existing secondary private key certificate and the primary private key certificate. Either signature may be obtained in no particular order. Those skilled in the art will recognize that the replacement public key certificate contains a public key which is used with equipment to replace an existing secondary public key. The preparation phase of the instant method will take place in equipment that is separate and apart from the electronic device(s) that will be updated. These preparations typically will occur well in advance of the actual update process. As described herein, the signing 403 may be considered a subset of the preparation process and uses a private key as part of the public/private key pair. After the replacement secondary certificate is retrieved 405, the validation process includes running the application on a processor of the device that will manage the upgrade of the certificate. This application will retrieve the signed certificate that has been created, bringing the replacement public certificate into the device on one or more of its communication ports.

When the primary signature and the existing secondary signature are validated 407, then a determination is made whether both signatures are valid 411 using a hash value as described herein. If either signature is invalid, then the replacement secondary certificate is again considered for upgrade 405 and the update process begins again. If both signatures are valid, then the new or “replacement” secondary public key certificate can fully replace the existing secondary certificate by overwriting the existing certificate in the rewritable memory 413 such as a flash memory, hard drive or the like. Those skilled in the art will also recognize that the same process remains in place for any subsequent replacements. Thus, if the new or replacement secondary public key certificate is going to be replaced, then the replacement certificate must be signed by the then existing secondary certificate. The method of the invention is also applicable to a method for securely exchanging public key certificates in an electronic device using only one level of public key.

Thus, the method of the invention allows self-revocation of a public key certificate that uses either a single signature or combination of double signatures to permit transfer of a signing authority to an independent third party. Once the original secondary public key is overwritten, the original secondary public key may no longer be used and the process is irreversible. Hence, the replacement public key certificate cannot be defaulted to the original public key certificate. Additionally, the method allows a rewriteable memory to be used to store the secondary public key certificate where the original root key can remain as the first authentication key for accessing the software and/or other data in the device.

While embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for securely exchanging public key certificates in an electronic device using a single level of public key comprising the steps of:
utilizing a replacement public key certificate to replace an original public key certificate;
signing the replacement public key certificate using a private key of the original public key certificate;
validating the signature of the original public key certificate; and
writing the replacement public key certificate to a memory where the original public key certificate can no longer be used as a default.

2. A method for securely exchanging public key certificates as in claim 1, wherein the step of writing includes the step of:
replacing the original public key certificate with the replacement public key certificate.

3. A method for securely exchanging public key certificates as in claim 1, wherein the original public key certificate is stored in a rewriteable memory.

4. A method for securely exchanging public key certificates as in claim 3, wherein the rewritable memory is a flash memory.

5. A method for securely exchanging public key certificates as in claim 1, wherein the replacement public key certificate is used to access data stored in memory within the electronic device.

6. A method for securely exchanging public key certificates as in claim 3, wherein the replacement public key certificate and the access data are stored in the same memory.

7. A method for securely exchanging public key certificates as in claim 1, wherein the electronic device is a two-way radio transceiver.

8. A method for exchanging public key certificates in an electronic device using a first public key certificate and a second public key certificate for authentication when accessing data in the device, comprising the steps of:
obtaining a third public key certificate to replace the second key certificate;
signing the third public key certificate with a root private key;
signing the third public key certificate with a private key from the second public key certificate;
validating the signature of the first key certificate and of the second key certificate; and
replacing the second public key certificate with the third public key certificate.

9. A method for exchanging public key certificates as in claim 8, wherein the step of replacing includes the step of overwriting the second public key certificate with the third public key certificate in a rewritable memory.

10. A method for exchanging public key certificates as in claim 8, wherein the first public key certificate is stored in a non-writeable memory to prevent it from being overwritten.

11. A method for exchanging public key certificates as in claim 8, wherein the second public key certificate and the data are stored in the rewritable memory.

12. A method for exchanging public key certificates as in claim 11, wherein the rewritable memory is a single memory.

13. A method for exchanging public key certificates as in claim 11, wherein the rewriteable memory is a hard drive.

14. A method for exchanging public key certificates as in claim 8, wherein the third public key certificate cannot be replaced with the second public key certificate as a default.

15. A method for exchanging public key certificates as in claim 8, wherein the electronic device is a two-way radio transceiver.

16. A method for securely exchanging public key certificates in an electronic device that utilizes a primary public key certificate and an original secondary public key certificate to authenticate data, comprising the steps of:
preparing a replacement secondary public key certificate to replace the original secondary public key certificate;
signing the replacement secondary public key certificate using at least one private key;
validating the signature of the primary public key certificate and the original secondary public key certificate; and
overwriting the original secondary public key certificate with the replacement secondary public key certificate so the original secondary public key certificate cannot be reused for access to the electronic device.

17. A method for securely exchanging public key certificates as in claim 16, wherein the at least one private key includes both the private key from the primary public key certificate and the private key from the original secondary public key certificate.

18. A method for securely exchanging public key certificates as in claim 16, wherein the primary public key certificate is stored in a non-writeable memory.

19. A method for securely exchanging public key certificates as in claim 16, wherein the secondary public key certificate is stored in a rewritable memory.

20. A method for securely exchanging public key certificates as in claim 16, wherein the primary public key certificate and the replacement public key certificate are used to access data stored in memory for operating the electronic device.
